(19) United States
(12) Patent Application Publication
(10) Pub. No.: US 2021/0231534 A1
(43) Pub. Date: Jul. 29, 2021

(54) EQUIPMENT MONITORING SYSTEM, EQUIPMENT MONITORING METHOD, AND RECORDING MEDIUM

(71) Applicant: NEC CORPORATION, Tokyo (JP)

(72) Inventor: Yuko OHTA, Tokyo (JP)

(73) Assignee: NEC CORPORATION, Tokyo (JP)

(21) Appl. No.: 15/734,824

(22) PCT Filed: May 30, 2019
(86) PCT No.: PCT/JP2019/021508

§ 371 Date: Dec. 3, 2020

(30) Foreign Application Priority Data
Jun. 4, 2018 (JP) 2018-106693

(51) Int. Cl. G01M 99/00; G06F 16/245

(52) U.S. Cl. CPC G01M 99/005; G06F 16/245

(57) ABSTRACT

An equipment monitoring system includes an abnormality/abnormality indication detecting means, a coping method database, a coping method extracting means, a visual confirmation availability determining means, a priority setting means, and a coping method notifying means. The abnormality/abnormality indication detecting means detects an abnormality or an abnormality indication of equipment. The coping method database stores a coping method for the abnormality or the abnormality indication, the coping method including visual confirmation. The coping method extracting means extracts the coping method for the detected abnormality or the detected abnormality indication from the coping method database. The visual confirmation availability determining means determines whether the extracted coping method includes visual confirmation. When there is a plurality of extracted coping methods, the priority setting means sets a high priority to the coping method including visual confirmation. The coping method notifying means makes a notification of the coping method based on the set priority.

### CROSS REFERENCE TO RELATED APPLICATIONS

This application is a National Stage of International Application No. PCT/JP2019/021508 filed May 30, 2019, claiming priority based on Japanese Patent Application No. 2018-106693 filed Jun. 4, 2018.

### TECHNICAL FIELD

The some non-limiting embodiments relates to an equipment monitoring system and the like.

### BACKGROUND ART

In various fields, introduction of equipment for labor saving and manpower saving is progressing. For example, equipment for automating provision of beverages and the like is increasingly introduced into retail stores. Such equipment has problems of an opportunity loss due to failure in the equipment and reduction in customer satisfaction (CS). In other words, reduction of response time when a failure has occurred in equipment is required. To reduce the response time, prompt execution of an effective coping method for the failure is necessary. Therefore, making a notification of the content of the failure and the coping method for the failure is widely performed when the failure has occurred. However, the method of simply making the notification of the coping method has a problem of not knowing which coping method should be adopted in the case where there is a plurality of coping methods.

A coping method having past performance is preferentially displayed. In this way, notification of the coping method estimated to be effective can be made to an operator in charge of maintenance.

### SUMMARY

### Technical Problem

However, since the past performance is used as a benchmark, a coping method that allows immediate visual confirmation is not necessarily preferentially displayed even if there is such a coping method. As a result, in some cases, a coping method that takes more time than visual confirmation is tried first and the time is lost.

The some non-limiting embodiments has been made in view of the above problem, and an object of the some non-limiting embodiments is to provide an equipment monitoring system that preferentially makes a notification of a coping method that allows visual confirmation for a failure in equipment.

### Solution to Problem

To solve the above problem, an equipment monitoring system of the some non-limiting embodiments includes an abnormality/abnormality indication detecting means, a coping method database, a coping method extracting means, a visual confirmation availability determining means, a priority setting means, and a coping method notifying means. The abnormality/abnormality indication detecting means detects an abnormality or an abnormality indication of equipment. The coping method database stores a coping method for the abnormality or the abnormality indication, the coping method including visual confirmation. The coping method extracting means extracts the coping method for the detected abnormality or the detected abnormality indication from the coping method database. The visual confirmation availability determining means determines whether the extracted coping method includes visual confirmation. In a case where there is a plurality of extracted coping methods, the priority setting means sets a high priority to the coping method including visual confirmation. The coping method notifying means makes a notification of the coping method based on the set priority.

### Advantageous Effects

An effect of the some non-limiting embodiments is to provide an equipment monitoring system that preferentially makes a notification of a coping method that allows visual confirmation for a failure in equipment.

### BRIEF DESCRIPTION OF DRAWINGS

FIG. 1 is a block diagram illustrating an equipment monitoring system according to a first example embodiment.

FIG. 2 is a block diagram illustrating a hardware configuration of the equipment monitoring system according to a second example embodiment.

FIG. 3 is a block diagram illustrating the equipment monitoring system according to the second example embodiment.

FIG. 4 is a flowchart illustrating an operation of the equipment monitoring system according to the second example embodiment.

FIG. 5 is a block diagram illustrating a specific example according to the second example embodiment.

FIG. 6 is a diagram illustrating an example of abnormality/abnormality indication detection data of a specific example according to the second example embodiment.

FIG. 7 is a diagram illustrating data examples of coping methods of a specific example according to the second example embodiment.

FIG. 8 is a diagram illustrating a display example of a notice of a coping method of a specific example according to the second example embodiment.

FIG. 9 is a diagram illustrating an example of a display screen of a specific example according to the second example embodiment.

FIG. 10 is a block diagram illustrating an equipment monitoring system according to a third example embodiment.

FIG. 11 is a flowchart illustrating an operation of the equipment monitoring system according to the third example embodiment.

FIG. 12 is a block diagram illustrating a specific example according to the third example embodiment.

FIG. 13 is a diagram illustrating an example of abnormality/abnormality indication detection data of a specific example of the third example embodiment.

FIG. 14 is a diagram illustrating a data example of a coping method of a specific example according to the third example embodiment.

FIG. 15 is a diagram illustrating an example of second abnormality/abnormality indication detection data of a specific example according to the third example embodiment.

FIG. 16 is a diagram illustrating a data example of a second coping method of a specific example according to the third example embodiment.

FIG. 17 is a diagram illustrating a priority determination example of a specific example of the third example embodiment.

FIG. 18 is a diagram illustrating a display example of a notice of a coping method of a specific example according to the third example embodiment.

FIG. 19 is a block diagram illustrating an equipment monitoring system according to a fourth example embodiment.

FIG. 20 is a flowchart illustrating an operation of the equipment monitoring system according to the fourth example embodiment.

FIG. 21 is a block diagram illustrating a specific example according to the fourth example embodiment.

FIG. 22 is a block diagram illustrating an example of an output device according to a fifth example embodiment.

FIG. 23 is a diagram illustrating a display example of a notice according to the fifth example embodiment.

FIG. 24 is a diagram illustrating another display example of the notice according to the fifth example embodiment.

FIG. 25 is a diagram illustrating a still another display example of the notice according to the fifth example embodiment.

### EXAMPLE EMBODIMENT

Hereinafter, example embodiments of the some non-limiting embodiments will be described in detail with reference to the drawings. Note that the example embodiments to be described below have technically favorable limitations for implementing the some non-limiting embodiments. However, the scope of the some non-limiting embodiments are not limited to below. The same reference numerals are given to similar constituent elements in the drawings, and description of the similar constituent elements may be omitted.

### First Example Embodiment

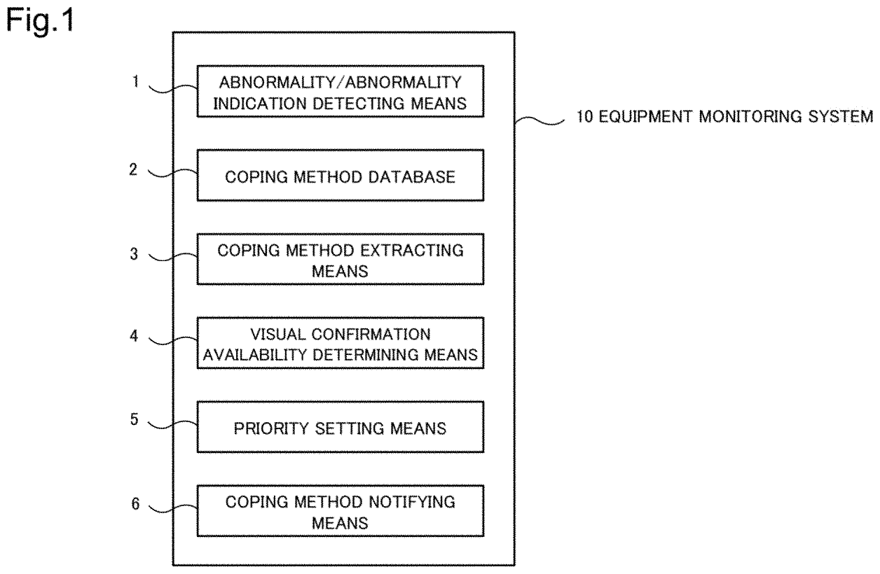

FIG. 1 is a block diagram illustrating an equipment monitoring system 10 according to a first example embodiment. The equipment monitoring system includes an abnormality or abnormality indication detecting means 1, a coping method database 2, a coping method extracting means 3, a visual confirmation availability determining means 4, a priority setting means 5, and a coping method notifying means 6.

The abnormality or abnormality indication detecting means 1 detects an abnormality or abnormality indication of equipment. Here, the abnormality indication is assumed to indicate a state in which the equipment is currently in a general state (or normal state) but there is a possibility of occurrence of an abnormal state in the future. The state in which there is a possibility of occurrence of an abnormal state means a state in which an event that is a sign of occurrence of an abnormal state has occurred even in the general state.

The coping method database 2 stores a coping method for the abnormality or abnormality indication. The coping method includes availability of visual confirmation.

The coping method extracting means 3 extracts the coping method for the detected abnormality or abnormality indication from the coping method database 2.

The visual confirmation availability determining means 4 determines whether the extracted coping method includes visual confirmation.

In a case where there is a plurality of extracted coping methods, the priority setting means 5 sets a high priority to the coping method including visual confirmation.

The coping method notifying means 6 makes a notification of the coping method based on the set priority.

As described above, according to the present example embodiment, the equipment monitoring system that preferentially makes the notification of the coping method that allows visual confirmation can be provided in the case where there is a plurality of the coping methods for the abnormality or abnormality indication.

### Second Example Embodiment

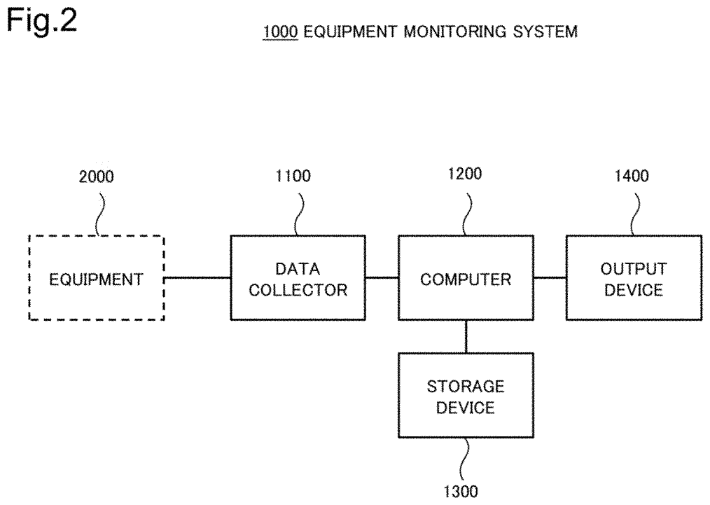

FIG. 2 is a block diagram illustrating a hardware configuration of the equipment monitoring system 1000 according to a second example embodiment. The equipment monitoring system 1000 includes a data collector 1100 that collects data from equipment 2000, a computer 1200 that processes the data, a storage device 1300 that stores the data, and an output device 1400.

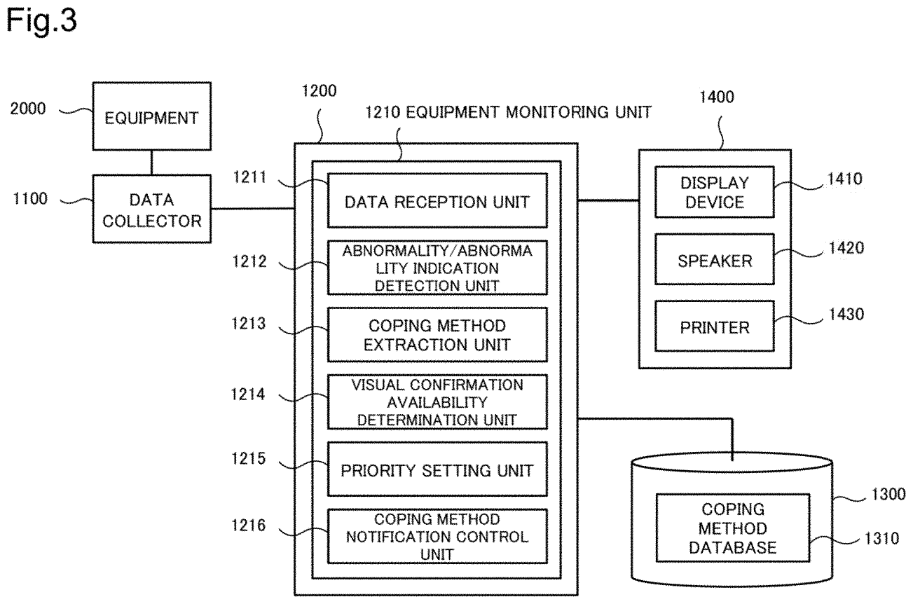

FIG. 3 is a block diagram illustrating functional blocks of the equipment monitoring system 1000. An equipment monitoring unit 1210 is mounted on the computer 1200. In the storage device 1300, a coping method database 1310 is implemented. As the output device 1400, for example, a display device 1410, a speaker 1420, a printer 1430, or the like can be used.

The equipment monitoring unit 1210 includes a data reception unit 1211, an abnormality or abnormality indication detection unit 1212, a coping method extraction unit 1213, a visual confirmation availability determination unit 1214, a priority setting unit 1215, and a coping method notification control unit 1216.

The data reception unit 1211 receives equipment monitoring data relating to a state and an operation condition of the equipment 2000 collected by the data collector 1100. In the following description, the equipment monitoring data may be abbreviated as monitoring data or simply data.

The abnormality or abnormality indication detection unit 1212 detects an abnormality or an abnormality indication of the received data and specifies content of the abnormality or the abnormality indication. As described above, the abnormality indication indicates a state in which an event that is a sign of occurrence of an abnormal state occurs. The coping method database 1310 stores various abnormalities and abnormality indications, and coping methods respectively related to the abnormalities and abnormality indications. In the following description, the database may be abbreviated as DB.

The coping method extraction unit 1213 extracts the coping method for the detected and specified abnormality or abnormality indication from the coping method database 1310.

The visual confirmation availability determination unit 1214 determines whether the extracted coping method allows visual confirmation.

In a case where there is a plurality of extracted coping methods, the priority setting unit 1215 sets a high priority to the coping method that allows visual confirmation.

The coping method notification control unit 1216 causes the output device 1400 to output the coping method to which the priority is given based on the priority. For example, a list of the coping methods reflecting priorities can be displayed on the display device 1410. Alternatively, a notification of the coping method may be made using a sound from the speaker 1420 or may be printed from the printer 1430.

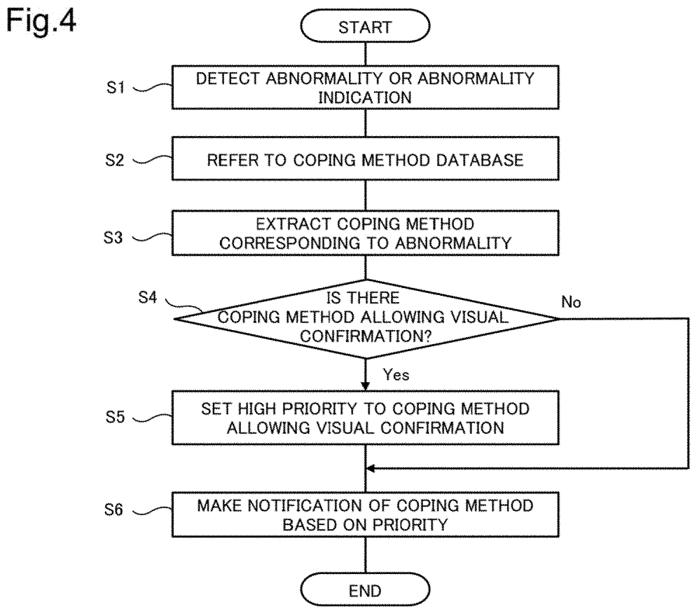

FIG. 4 is a flowchart illustrating an operation of the equipment monitoring system 1000. First, the equipment monitoring system 1000 analyzes the received equipment monitoring data and detects the abnormality or abnormality indication (S1). At this time, the equipment monitoring system 1000 specifies, from an analysis result, the type of the abnormality or abnormality indication to the extent possible. The specified abnormality or abnormality indication can be managed giving an error code for each type, for example. Next, the equipment monitoring system 1000 refers to the coping method database (S2) and extracts the coping method related to the specified abnormality or abnormality indication (S3). Next, the equipment monitoring system 1000 determines whether visual confirmation is available for each extracted coping method (S4). Whether visual confirmation is available can be identified by, for example, giving a flag indicating the availability of visual confirmation to the data of the coping method stored in the coping method database. In the case where the extracted coping method allows visual confirmation (S4_Yes), the equipment monitoring system 1000 sets a high priority to the coping method (S5). On the other hand, in the case where the visual confirmation is not available for the extracted coping method (S4_No), the equipment monitoring system 1000 proceeds to the next step without giving a high priority to the coping method. Next, the equipment monitoring system 1000 makes a notification of the coping method according to the set priority (S6). As described above, the notification can be performed by display on a display device, sound, printing, or the like.

### Specific Example 1

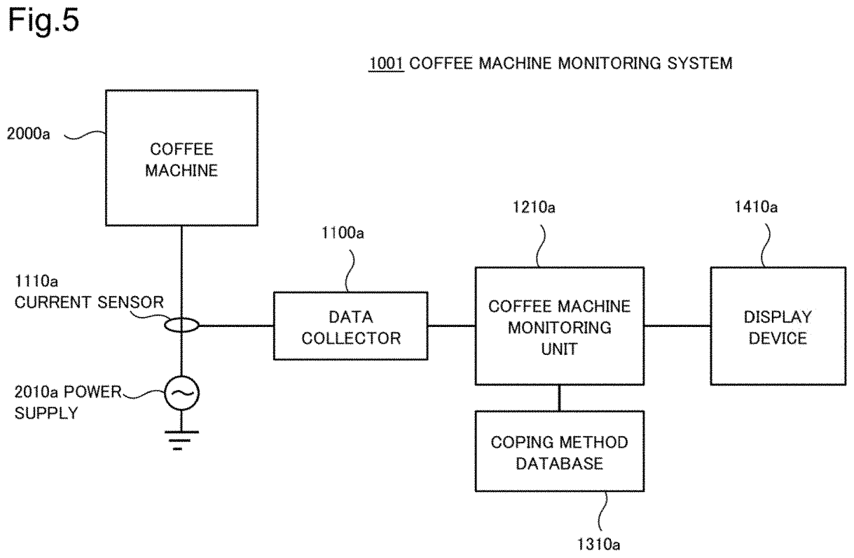

Next, a specific example using a coffee machine installed in a store as equipment will be described. FIG. 5 is a block diagram illustrating a coffee machine monitoring system 1001 of a specific example 1. The coffee machine monitoring system 1001 includes a data collector 1100a, a coffee machine monitoring unit 1210a, a coping method database 1310a, and a display device 1410a. In the present specific example, a current waveform of a coffee machine 2000a collected by a current sensor 1110a is used as the equipment monitoring data. The data collector 1100a samples a current value at predetermined sampling time. The coffee machine monitoring unit 1210a analyzes the current waveform, detects an abnormality or an abnormality indication, and specifies a type of the abnormality or the abnormality indication. The coffee machine monitoring unit 1210a gives an error code to the specified abnormality or abnormality indication.

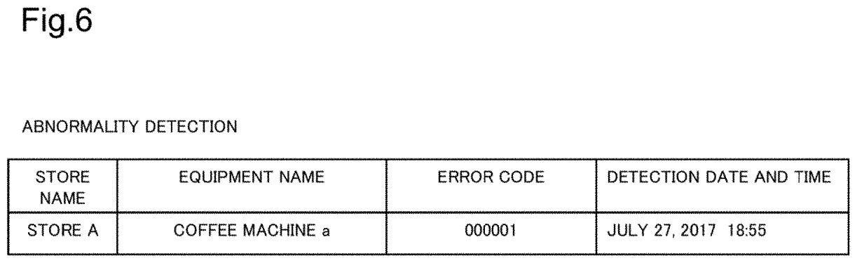

FIG. 6 is a diagram illustrating an example of an abnormality or abnormality indication detection result. In this example, an abnormality of error code 000001 has been detected at 18:55 on Jul. 27, 2017 in a coffee machine a of a store A.

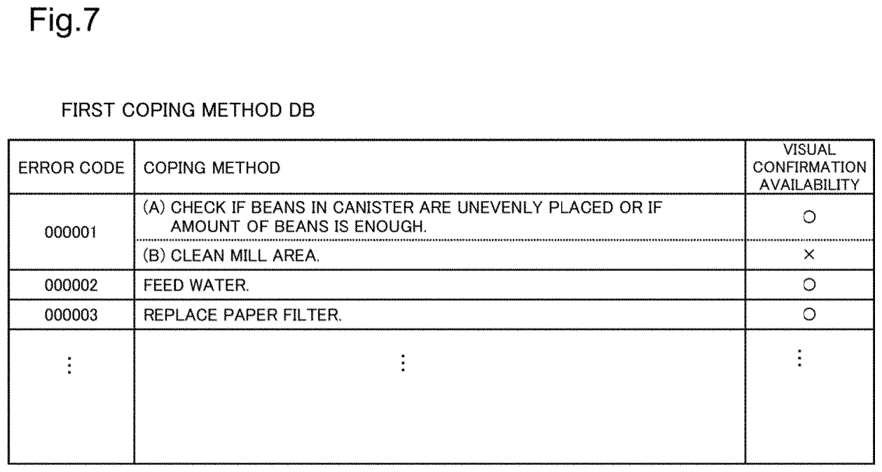

The coffee machine monitoring unit 1210a extracts a coping method related to the error code 000001 from the coping method database 1310a. FIG. 7 is a diagram illustrating examples of coping methods stored in the coping method database 1310a. The coping methods for the error code 000001 include “(A) Check if the beans in the canister are unevenly placed or if the amount of beans is enough.” and “(B) Clean the mill area”. Visual confirmation is available for (A) and visual confirmation is not available for (B). Therefore, the coffee machine monitoring unit 1210a gives a high priority to (A).

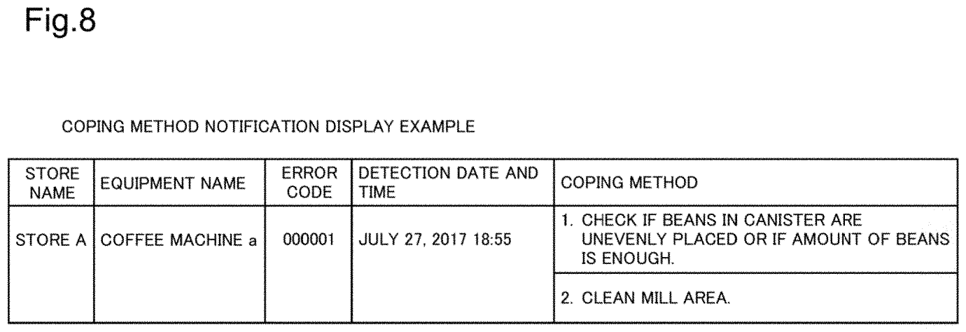

FIG. 8 is a diagram illustrating an example of display for making a notification of a coping method. In the example in FIG. 8, content of (A) is displayed in 1 of the coping method, and content of (B) is displayed in 2 of the coping method. The coffee machine monitoring unit 1210a can make the notification to a user to perform the coping method of (A) first, which allows visual confirmation, according to the display.

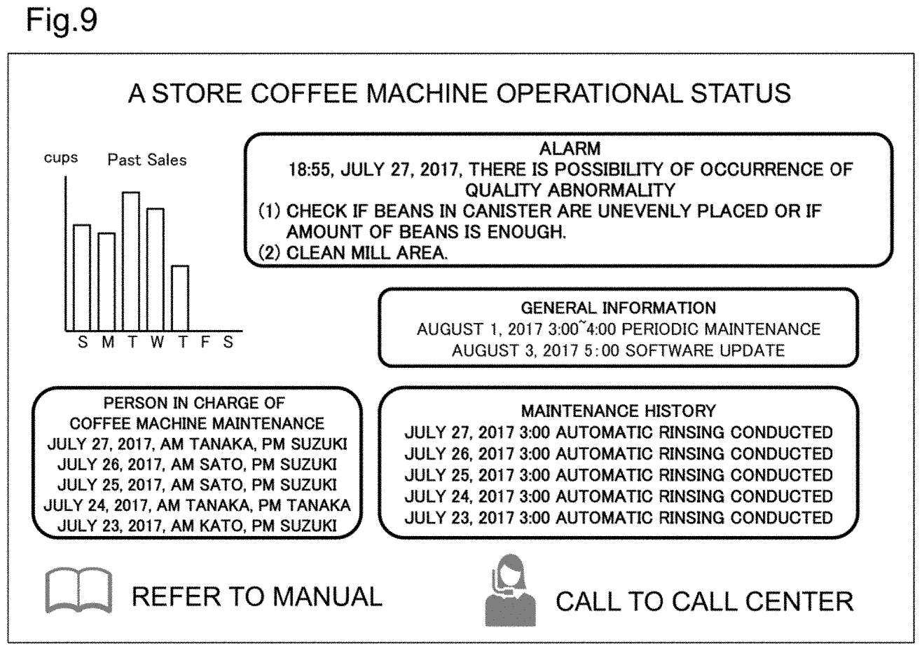

FIG. 9 is a diagram illustrating a display example on a display screen serving as a user interface. The display device is, for example, a display of a terminal for managing equipment in a store. On the display screen, content of abnormalities and an alarm prompting action are displayed, and “Check if the beans in the canister are unevenly placed or if the amount of beans is enough.” is recommended to be executed first. Further, another information regarding maintenance of the coffee machine is displayed together. Moreover, an icon for referring to the manual and an icon for making a call to the call center. In addition, a graph of sales is displayed. By referring to such a display screen, the user can promptly learn the effective coping method.

As described above, according to the present example embodiment, a notification can be made to the user to execute the coping method that allows visual confirmation first, in the case where an abnormality or abnormality indication of equipment has been detected.

### Third Example Embodiment

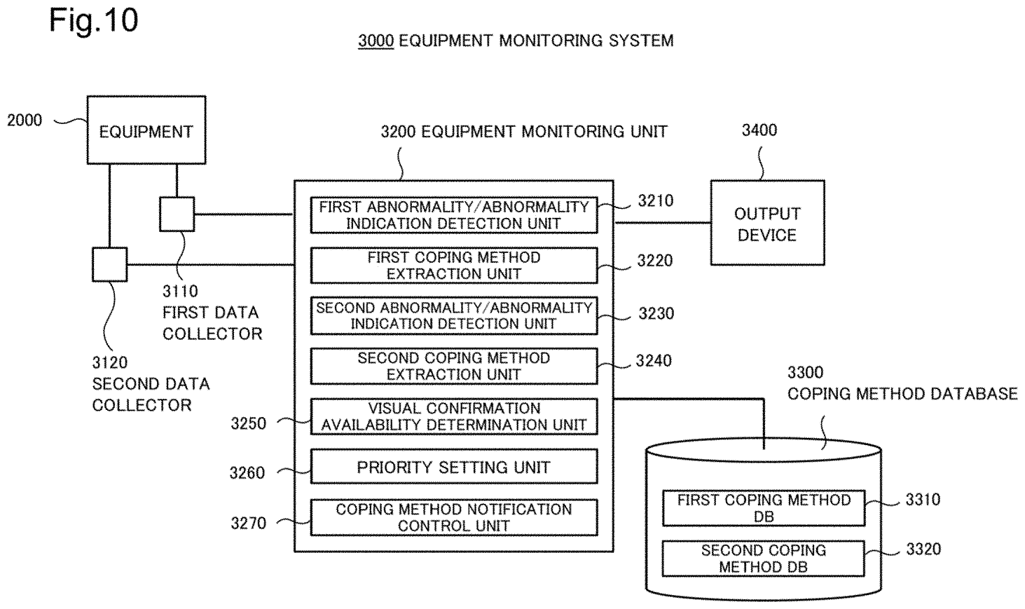

FIG. 10 is a block diagram illustrating an equipment monitoring system 3000 according to a third example embodiment. In FIG. 10, illustration of hardware is omitted.

The equipment monitoring system 3000 of the present example embodiment collects two types of data: first data and second data from equipment 2000 as equipment monitoring data. By collecting two types of data, a more detailed analysis of an abnormality or abnormality indication is performed.

The equipment monitoring system 3000 includes a first data collector 3110, a second data collector 3120, an equipment monitoring unit 3200, a coping method database 3300, and an output device 3400.

The equipment monitoring unit 3200 includes a first abnormality or abnormality indication detection unit 3210, a first coping method extraction unit 3220, a second abnormality or abnormality indication detection unit 3230, and a second coping method extraction unit 3240. Further, the equipment monitoring unit 3200 includes a visual confirmation availability determination unit 3250, a priority setting unit 3260, and a coping method notification control 3270. In FIG. 10, illustration of a data reception unit for receiving data is omitted.

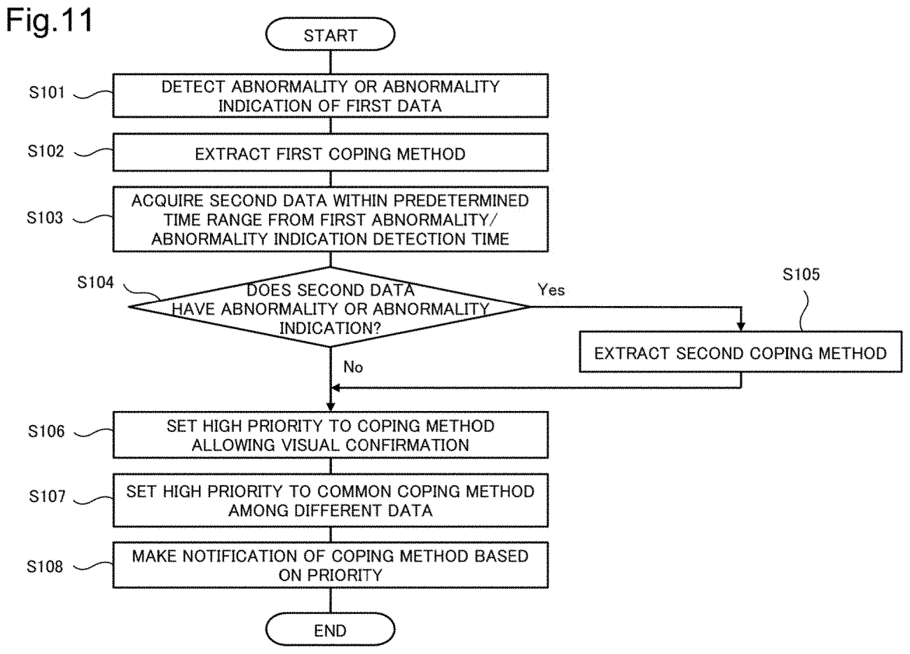

FIG. 11 is a flowchart illustrating an operation of the equipment monitoring system 3000. In the following description, it is assumed that the first data is used for roughly monitoring an abnormality or abnormality indication, and the second data is used for detailed analysis, but use of the data is not limited to such division of roles.

The equipment monitoring system 3000 first detects an abnormality or abnormality indication of the first data (S101). Next, the equipment monitoring system 3000 extracts a coping method related to the abnormality or abnormality indication of the first data from a first coping method DB 3310 (S102).

Next, the equipment monitoring system 3000 acquires the second data within a predetermined time range from a time when the abnormality or abnormality indication of the first data is detected. The predetermined range can be determined to include the number of samples sufficient for detecting the presence or absence of the abnormality or abnormality indication of the second data, for example. Further, in the case where a relationship between timing when the abnormality or abnormality indication of the first data appears and timing when the abnormality or abnormality indication of the second data appears is known, the predetermined range may be determined based on the relationship. For example, assume that the first data is a current waveform and the second data is acoustic data. For example, it is assumed that, when an abnormality occurs in a slide rail, a current fluctuation due to a load fluctuation of a motor occurs, and a high possibility of occurrence of abnormal noise within a few minutes from the fluctuations is known in advance. In this case, it is effective to acquire the acoustic data of about 10 minutes before and after an abnormality detection time of the current waveform. Then, in the case where the abnormality or abnormality indication is detected in the acquired second data (S104_Yes), the equipment monitoring system 3000 extracts the coping method related to the abnormality or abnormality indication of the second data from a second coping method DB (S105). Then, the operation proceeds to S106. On the other hand, in the case where there is no abnormality or abnormality indication in the second data (S104_No), the operation directly proceeds to S106. The extraction of the first coping method and the extraction of the second coping method may be in no particular order.

In S106, the equipment monitoring system 3000 determines whether there is a coping method that allows visual confirmation between the extracted first coping method and second coping method, and sets a high priority to the coping method that allows visual confirmation. In the case where there is a plurality of appropriate coping methods, a rule for determining the priority may be separately determined. For example, a cumulative number of times recovered by a coping method is large, the coping method may be given a high priority. However, the example embodiment is not limited to these method and rule, and the method and rule may be appropriately determined according to the purpose. Next, if there is a coping method common to the extracted first coping method and second coping method, the equipment monitoring system 3000 sets a highest priority next to the coping method that allows the visual confirmation to the common coping method (S107). Then, the equipment monitoring system 3000 makes a notification of the coping method to the output device based on the set priority (S108). As described above, by using the two types of monitoring data, the probability of promptly performing an effective countermeasure can be increased.

### Specific Example 2

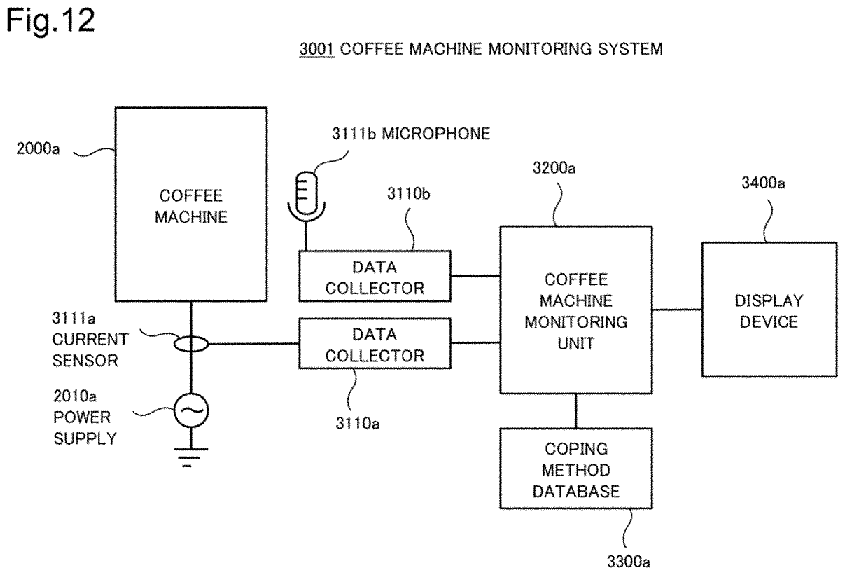

Next, a specific example of the third example embodiment will be described. As in the second example embodiment, an example of a coffee machine is used. FIG. 12 is a block diagram illustrating a coffee machine monitoring system 3001. The coffee machine monitoring system 3001 includes a microphone 3111b for acquiring acoustic data generated from a coffee machine 2000a and a data collector 3110b, in addition to the configuration of the specific example 1. The coffee machine monitoring system 3001 uses a current waveform as the first data and acoustic data as the second data. In FIG. 12, the microphone 3111b is illustrated outside the coffee machine 2000a, but the microphone may be installed inside or outside the machine.

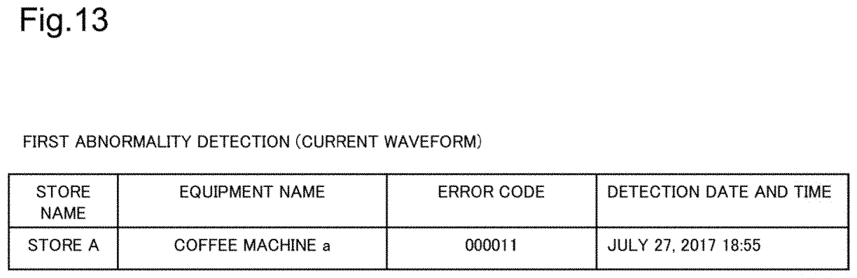

FIG. 13 is a diagram illustrating an example of a detection result when an abnormality of the current waveform as the first data is detected. The coffee machine monitoring system 3001 has detected an abnormality of error code 000011 at 18:55 on Jul. 27, 2017.

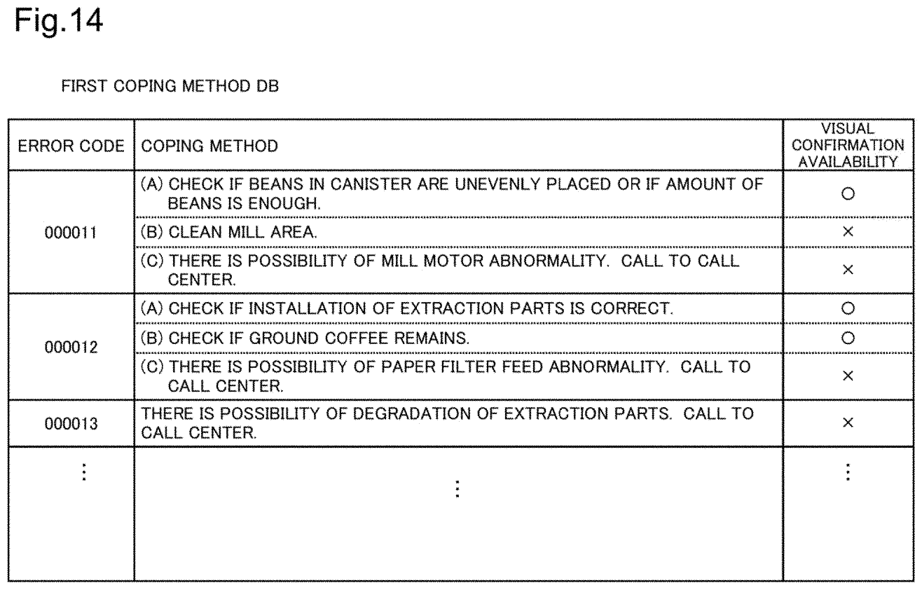

FIG. 14 is a diagram illustrating data of the first coping method including a coping method related to the error code 000011. There are three coping methods of (A), (B), and (C) for the abnormality of the error code 000011, and only the coping method (A) allows visual confirmation among the three coping methods.

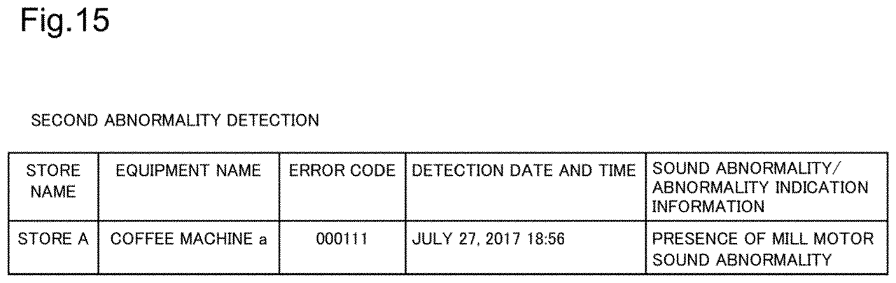

FIG. 15 is a diagram illustrating an example of a detection result of detecting an abnormality of the acoustic data as the second data. An abnormality of error code 000111, abnormal mill motor sound has been detected at 18:56 at about the same time as when the abnormality of the first data was detected.

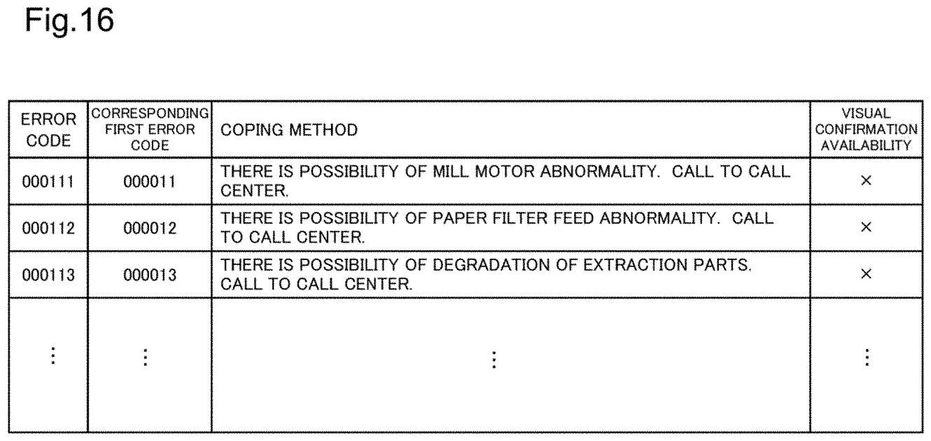

FIG. 16 is a diagram illustrating a list of coping methods for the second abnormality including the coping method related to the error code 000111. In the case where there is the same coping method in the first coping method, the related error code is listed together.

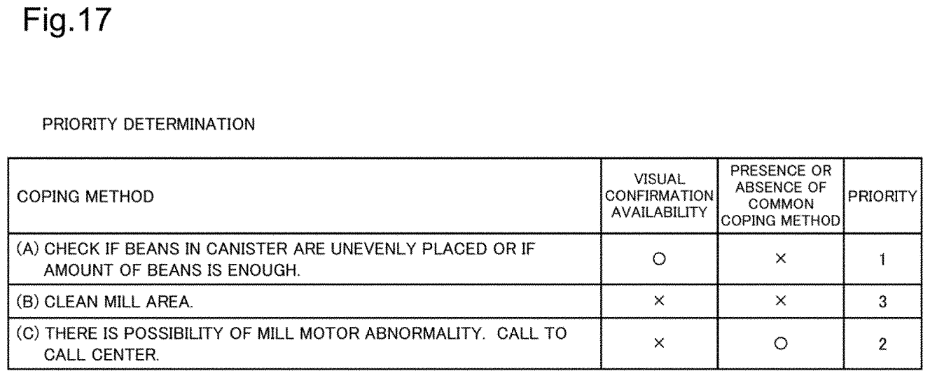

FIG. 17 is a diagram illustrating a priority determination example. In this example, a rule of giving a priority in order of 1) visual confirmation is available, 2) there is a coping method common to the first coping method and the second coping method, and 3) neither 1) nor 2) is applied. Therefore, the priority of (A) in which visual confirmation is available is set to 1, the priority of (C) that is the common coping method is set to 2, and the priority of (B) that is neither 1) nor 2) is set to 3.

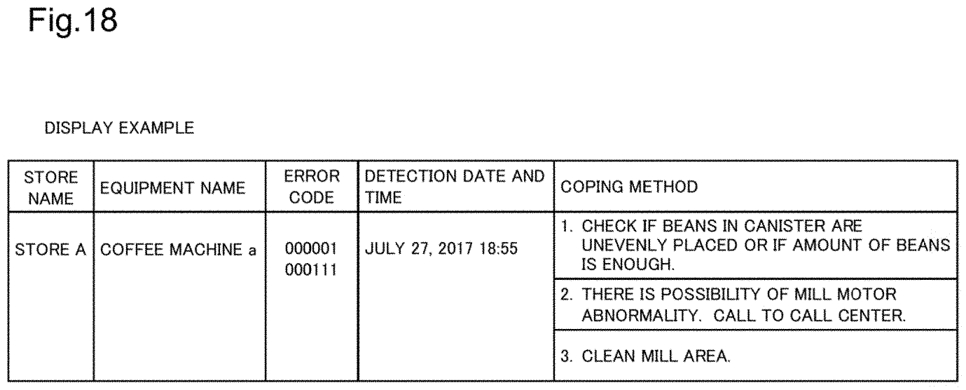

FIG. 18 is a diagram illustrating an example of displaying the coping methods according to the priority in FIG. 17. Displaying “Check if the beans in the canister are unevenly placed or if the amount of beans is enough.” of (A) at the top of the list indicates that the coping method should be executed first.

### Fourth Example Embodiment

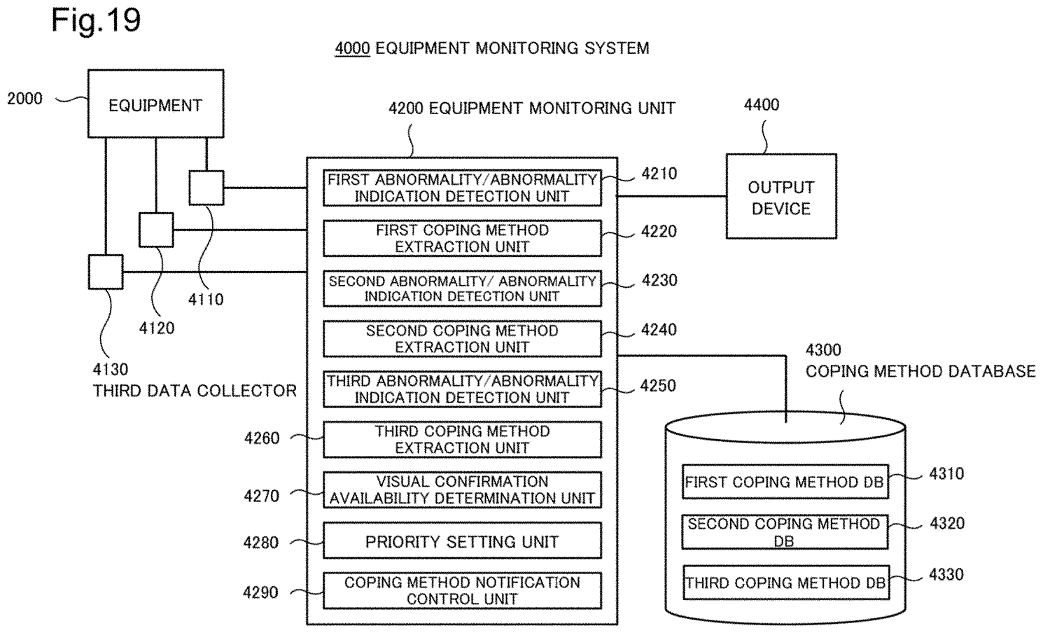

FIG. 19 is a block diagram illustrating an equipment monitoring system 4000 according to a fourth example embodiment. The equipment monitoring system 4000 according to the present example embodiment uses third equipment monitoring data, in addition to having the configuration of the equipment monitoring system 3000 of the third example embodiment. For this purpose, the equipment monitoring system 4000 includes a third data collector 4130, a third abnormality or abnormality indication detection unit 4250, a third coping method DB 4330, and a third coping method extraction unit 4260. That is, the equipment monitoring system 4000 includes a set of the data collectors, the abnormality or abnormality indication detection units, the coping method DBs, and the coping method extraction units for the first, second, and third data.

An equipment monitoring unit 4200 includes a first abnormality or abnormality indication detection unit 4210, a first coping method extraction unit 4220, a second abnormality or abnormality indication detection unit 4230, and a second coping method extraction unit 4240, similarly to the third example embodiment. Moreover, the equipment monitoring unit 4200 includes the third abnormality or abnormality indication detection unit 4250 and the third coping method extraction unit 4260. Further, the equipment monitoring unit 4200 includes a visual confirmation availability determination unit 4270, a priority setting unit 4280, and a coping method notification control 4290. In FIG. 19, illustration of a data reception unit for receiving data is omitted. In the present example embodiment, the equipment monitoring unit 4200 detects three types of abnormalities or abnormality indications different from one another.

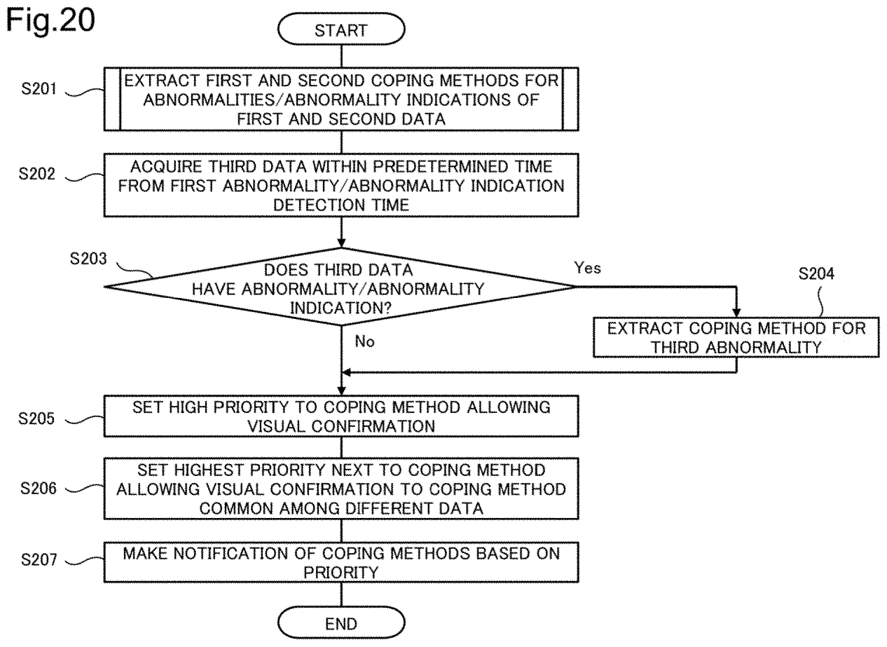

FIG. 20 is a flowchart illustrating an operation of the equipment monitoring system 4000. The equipment monitoring system 4000 extracts coping methods for the abnormalities or abnormality indications of first and second data (S201). S201 is processing from S101 to S105 in the flowchart in FIG. 11 of the third example embodiment. Therefore, although illustration is omitted in FIG. 20, content of S201 will be described again with reference to FIG. 11. First, the equipment monitoring system 4000 detects the abnormality or abnormality indication of the first data (S101). The equipment monitoring system 4000 extracts the coping method related to the abnormality or abnormality indication of the first data from a first coping method DB 4310 (S102). Next, the equipment monitoring system 4000 acquires the second data within a predetermined time range from the time when the abnormality or abnormality indication of the first data is detected (S103) and determines whether the second data has the abnormality or abnormality indication (S104). Here, in the case where the second data has the abnormality or abnormality indication (S104_Yes), the equipment monitoring system 4000 extracts a second coping method (S105). With the above operation, the equipment monitoring system 4000 executes the process of S201.

Next, the equipment monitoring system 4000 acquires the third data within a predetermined range from the time when the abnormality or abnormality indication of the first data is detected (S202) and determines whether the acquired third data has the abnormality or abnormality indication (S203). Here, in the case where the third data has the abnormality or abnormality indication (S203_Yes), the equipment monitoring system 4000 extracts a third coping method (S204) and proceeds to S205. On the other hand, in the case where there the third data has no abnormality or abnormality indication (S203_No), the equipment monitoring system 4000 directly proceeds to S205.

In S205, the equipment monitoring system 4000 sets a high priority to the coping method that allows visual confirmation among the extracted three types of coping methods. Next, if there is a coping method common to different data among the extracted three types of coping methods, the equipment monitoring system 4000 sets a highest priority next to the coping method that allows the visual confirmation to the common coping method (S206). Then, the equipment monitoring system 4000 makes a notification of the coping methods according to the set priority (S207). As described above, by using the three types of monitoring data, the probability of preferentially performing an effective coping method can be increased. Similarly, it is also possible to increase the probability of selecting a more effective coping method using four or more types of equipment monitoring data.

As described above, the present example embodiment enables prompt execution of the coping method that allows visual confirmation and can increase the probability of selecting an effective coping method.

### Specific Example 3

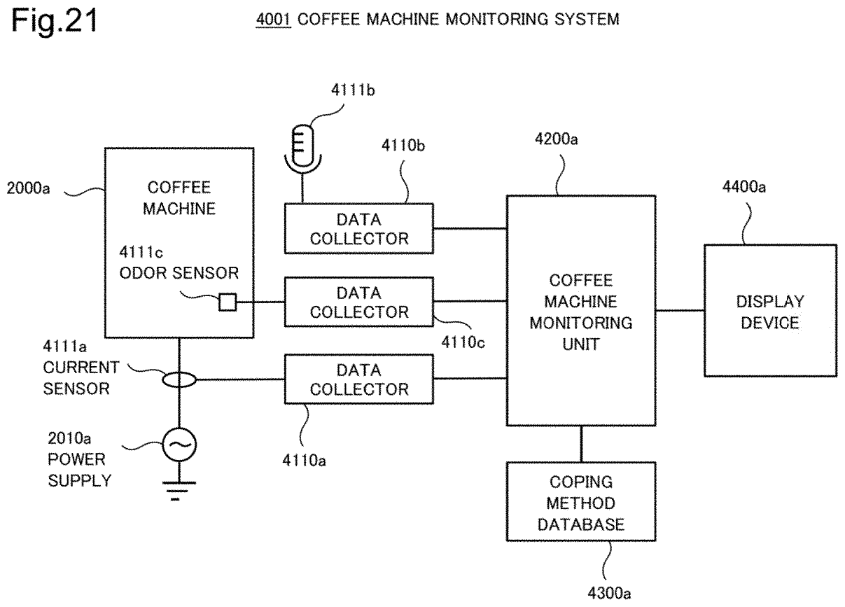

FIG. 21 is a block diagram illustrating a coffee machine monitoring system 4001 of a specific example 3. The coffee machine monitoring system 4001 includes an odor sensor 4111c and a data collector 4110c, in addition to the configuration of the specific example 2. In FIG. 21, the odor sensor 4111c is illustrated in an interior of the equipment but may be installed either inside or outside the equipment. In this specific example, an odor is added as the equipment monitoring data, whereby the probability of selecting an effective coping method for the abnormality or abnormality indication is improved.

### Fifth Example Embodiment

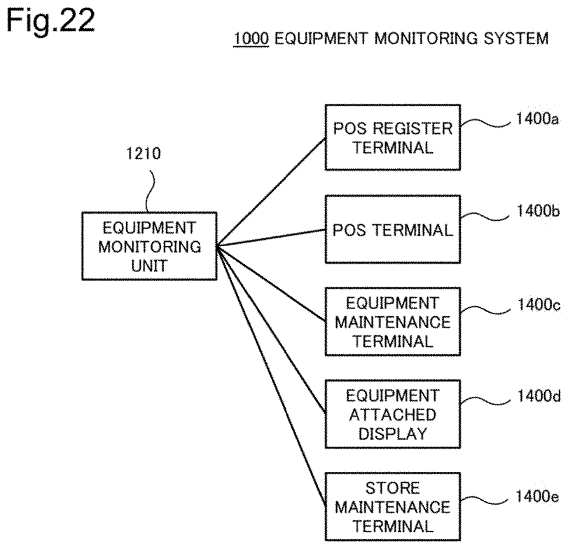

In the present example embodiment, an example of an output device will be described. FIG. 22 is a block diagram illustrating an output device according to the present example embodiment. A list of coping methods prepared by an equipment monitoring unit 1210 can be output to, as illustrated in FIG. 22, a POS register terminal 1400a, a POS terminal 1400b, an equipment maintenance terminal 1400c, an equipment attached display 1400d, a store maintenance terminal 1400e, or the like. Here, the store maintenance terminal 1400e can also serve as, for example, an ordering terminal.

The list of coping methods may be displayed on the store maintenance terminal 1400e, may be displayed on the POS terminal 1400b, or may be simultaneously displayed on a plurality of terminals including another terminal. Further, the list of coping methods may be given in PUSH-notification to the POS terminal 1400b and is guided to the store maintenance terminal 1400e, and details may be displayed on the store maintenance terminal 1400e. Alternatively, the same data may be displayed on a maintenance screen of the equipment attached display 1400d. The above-mentioned POS stands for Point Of Sales. POS terminals are frequently used in retail stores. The first to fourth equipment monitoring systems can be easily incorporated into such a POS system.

### Specific Example 4

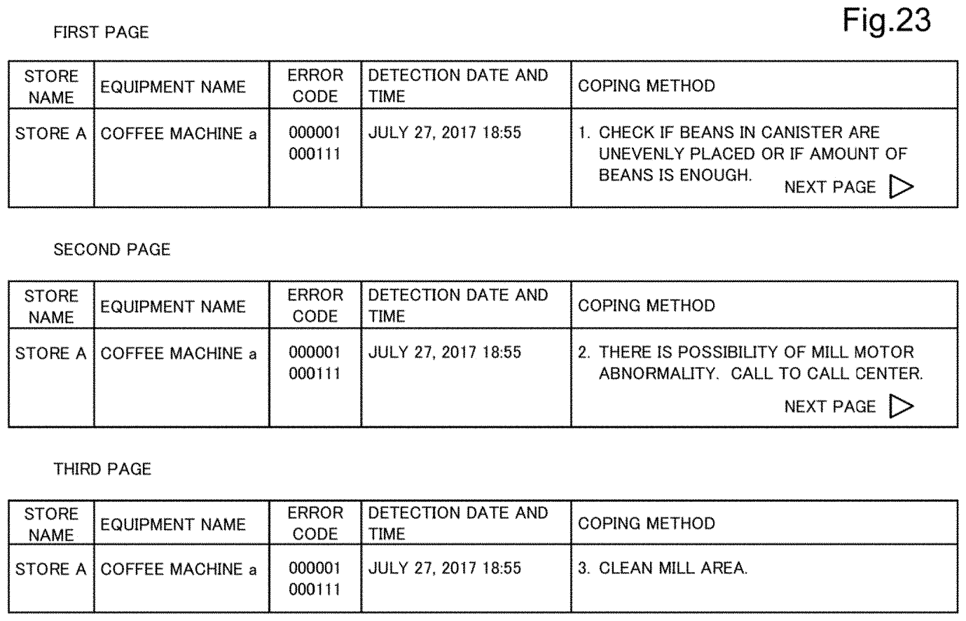

In the present specific example, a display example in the case where a display device is used as an output device will be described. FIG. 23 is a diagram illustrating a display example. In FIG. 23, one coping method is displayed on one page, and the coping methods are arranged in the order of priority. By sending a page, the next coping method is displayed.

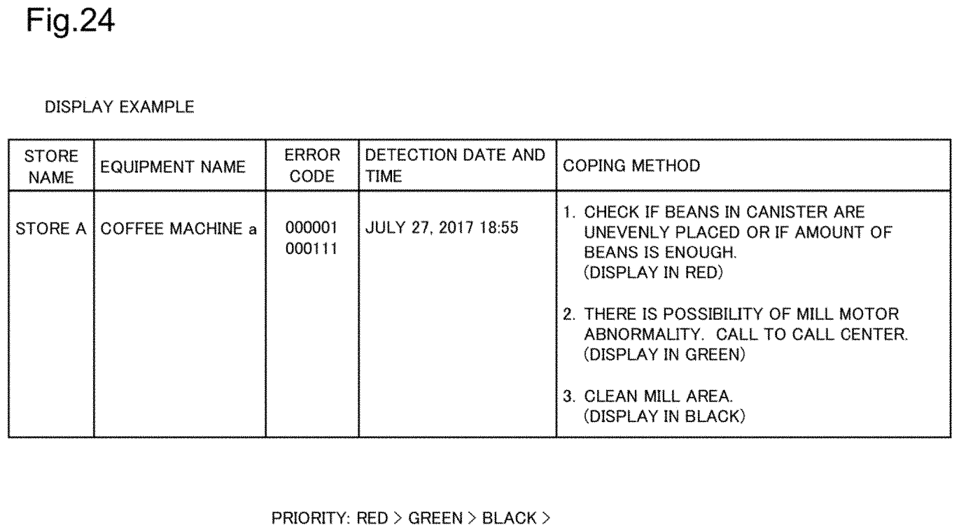

Further, FIG. 24 illustrates an example in which the priority is indicated by color instead of arrangement on the screen. Here, the coping method are displayed in red>green>black in descending order of priority.

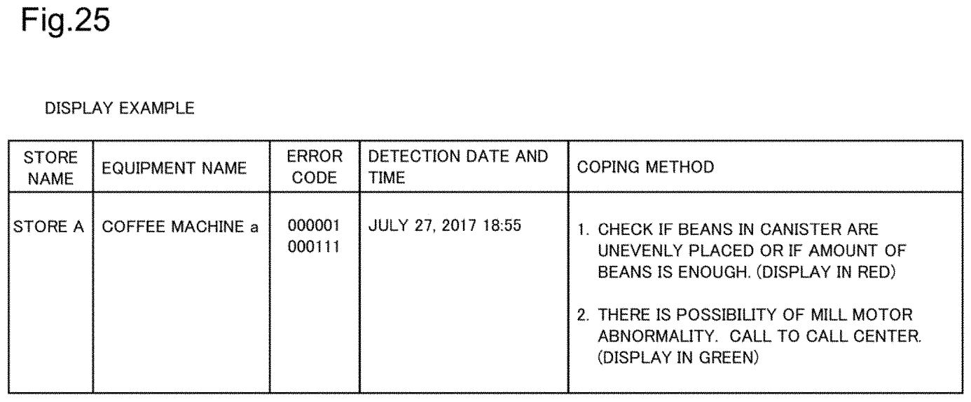

Further, in FIG. 25, only coping methods having high priority (here, two coping methods) are displayed.

As described above, according to the present example embodiment, an equipment monitoring system suitable for operation in a store or the like can be provided.

A program for causing a computer to execute the processing according to the first to fifth example embodiments and a recording medium storing the program are also included in the scope of the some non-limiting embodiments. As the recording medium, for example, a magnetic disk, a magnetic tape, an optical disk, a magneto-optical disk, a semiconductor memory, or the like can be used.

The some non-limiting embodiments has been described with reference to the above-described example embodiments as exemplary examples. However, the some non-limiting embodiments is not limited to the above-described example embodiments. That is, various aspects that will be understood by those of ordinary skill in the art can be applied without departing from the spirit and scope of the some non-limiting embodiments as defined by the claims.

This application is based upon and claims the benefit of priority from Japanese patent application No. 2018-106693, filed on Jun. 4, 2018, the disclosure of which is incorporated herein in its entirety by reference.

### REFERENCE SIGNS LIST

1 abnormality or abnormality indication detecting means
2, 1310, 3300 coping method database
3 coping method extracting means
4 visual confirmation availability determining means
5 priority setting means
6 coping method notifying means
10, 1000, 3000, 4000 equipment monitoring system
1100 data collector
1200 computer
1300 storage device
1400 output device
1210, 3200, 4200 equipment monitoring unit

1. An equipment monitoring apparatus comprising:
at least one memory storing instructions; and
one or more processors configured to execute the instructions to:
detect at least one of an abnormality and an abnormality indication of equipment;
extract a coping method for the detected at least one of the abnormality and the detected abnormality indication from a database;
determine whether the extracted coping method includes a visual confirmation; and
make a notification of the coping method including a virtual confirmation priority, in a case where the extracted coping method includes the visual confirmation.

2. The equipment monitoring apparatus system according to claim 1, wherein
the one or more processors are further configured to execute the instructions to:
collect first equipment monitoring data of the equipment.

3. The equipment monitoring apparatus according to claim 2, wherein
the one or more processors are further configured to execute the instructions to:
collect second equipment monitoring data of the equipment, the second equipment monitoring data being different from the first equipment monitoring data.

4. The equipment monitoring apparatus according to claim 3, wherein
the one or more processors are further configured to execute the instructions to:
collect third equipment monitoring data of the equipment, the third equipment monitoring data being different from the first equipment monitoring data and the second equipment monitoring data.

5. The equipment monitoring apparatus according to claim 3, wherein, in a case where the coping method is common to the at least one of the abnormality and the abnormality indication detected in a different equipment monitoring data, a high priority is set to the coping method.

6. The equipment monitoring apparatus according to claim 3, wherein
the second equipment monitoring data vindicates at least one of an acoustic signal and an odor signal.

7. The equipment monitoring apparatus according to claim 2, wherein
the first equipment monitoring data is a current waveform.

8. (canceled)

9. An equipment monitoring method comprising:
by a computer,
detecting at least one of an abnormality and an abnormality indication of equipment;
extracting a coping method for the at least one of the detected abnormality and the detected abnormality indication from a database;
determining whether the extracted coping method includes a visual confirmation; and
making a notification of the coping method including a virtual confirmation priority, in a case where the extracted coping method includes the visual confirmation.

10. (canceled)

11. The equipment monitoring apparatus according to claim 1, wherein
the one or more processors are further configured to execute the instructions to:
determine to set a high priority to the coping method in a case where there is a plurality of the extracted coping methods and the coping method includes the visual confirmation; and
make the notification of the coping method based on the high priority.

12. The equipment monitoring apparatus according to claim 2, wherein
the one or more processors are further configured to execute the instructions to detect the at least one of the abnormality and the abnormality indication of the equipment by analyzing the first equipment monitoring data.

13. The equipment monitoring apparatus according to claim 3, wherein
the one or more processors are further configured to execute the instructions to detect the at least one of the abnormality and the abnormality indication of the equipment by analyzing the second equipment monitoring data.

14. The equipment monitoring apparatus according to claim 4, wherein
the one or more processors are further configured to execute the instructions to detect the at least one of the abnormality and the abnormality indication of the equipment by analyzing the third equipment monitoring data.

15. The equipment monitoring apparatus according to claim 4, wherein
the second equipment monitoring data indicates an acoustic signal; and
the third equipment monitoring data indicates an odor signal.

16. The equipment monitoring apparatus according to claim 4, wherein
the equipment is a coffee machine installed in a store.

17. The equipment monitoring apparatus according to claim 4, wherein
the abnormality indication indicates a state in which the equipment is currently in a normal state and a possibility of occurrence of an abnormal state in the future.

18. An monitoring system comprising:
at least one coffee machine;
a monitoring apparatus; and
a display device;
wherein the at least one coffee machine includes:
at least one first memory storing first instructions; and
one or more first processors configured to execute the first instructions to:
acquire first monitoring data corresponding to the at least one coffee machine; and
transmit the first monitoring data to the monitoring apparatus;
wherein the monitoring apparatus includes:
at least one second memory storing second instructions; and
one or more second processors configured to execute the second instructions to:
detect an abnormality indication of the at least one coffee machine by analyzing the first monitoring data;
extract a coping method for the detected abnormality indication from a database;
determine whether the extracted coping method includes a visual confirmation; and
output, to the display device, a notification of the coping method including a virtual confirmation priority, in a case where the extracted coping method includes the visual confirmation, and
wherein the display device includes:
at least one third memory storing third instructions; and
one or more third processors configured to execute the third instructions to display the notification received from the monitoring apparatus.

19. The monitoring system according to claim 18, wherein the display device is configured to display content of abnormalities and an alarm prompting action.

20. The monitoring system according to claim 18, wherein the display device is configured to display information regarding maintenance of the coffee machine.

21. The monitoring system according to claim 18, wherein the display device is configured to display an icon, for referring to a manual, and an icon for making a call to the call center.
